(19) United States
(12) Patent Application Publication
(10) Pub. No.: US 2020/0283921 A1
(43) Pub. Date: Sep. 10, 2020

(54) PROCESS FOR EXTRACTION AND PRODUCTION OF LITHIUM SALT PRODUCTS FROM BRINE

(71) Applicant: LIEP ENERGY LTD., CALGARY (CA)

(72) Inventor: Michael MISLAN, Calgary (CA)

(21) Appl. No.: 16/805,063

(22) Filed: Feb. 28, 2020

(30) Foreign Application Priority Data
Mar. 8, 2019 (CA) 3036143

(51) Int. Cl. C25C 1/02; H01M 4/38; H01M 10/0525

(52) U.S. Cl. CPC C25C 1/02; H01M 10/0525; H01M 4/382

(57) ABSTRACT

A method for extracting lithium from brine, said method comprising the steps of: providing a brine containing lithium; processing the brine to remove contaminants; submitting the brine to an electrochemical extraction of lithium; disposing of the lithium-depleted brine; adding water to the extracted lithium to create a lithium solution; performing an electrolytic alkylation on the lithium solution; exposing the lithium solution to crystallization and evaporation; and recovering the lithium salt resulting therefrom.

### CROSS-REFERENCE TO RELATED APPLICATIONS

This application claims the benefit of Canadian Patent Application No. 3,036,143 filed Mar. 8, 2019, the entire contents of which are incorporated herein by reference in its entirety.

### FIELD OF THE INVENTION

The technical field relates to the production of lithium salt products from brines using a combined electrochemical extraction and production process.

### BACKGROUND OF THE INVENTION

Lithium ion batteries have emerged to become the dominant electrochemical energy storage technology due to their ability to provide high specific energy density and charging behavior over hundreds to thousands of recharge cycles. The accelerating production of electric vehicles, renewable energy storage systems, drones, electronics and robotics suggests the demand for batteries and hence new lithium sources and extraction processes must be developed to meet increasing demand.

Existing lithium production techniques from brines generally consist of two steps: the lithium content is first concentrated then transformed into a solid product for sale. Traditional techniques for the concentration of lithium include evaporation ponds, solvent extraction, membrane filtration, adsorption, selective precipitation and others but all seek to produce a liquid stream concentrated in lithium. In general caustic soda or similar alkali is added to the concentrated lithium solution to precipitate lithium carbonate or a similar lithium salt for sale. These processes often have high operational costs due to consumables such as acids or bases to changes pH, adsorbents which can granulate after multiple cycles or highly selective but expensive membranes which can quickly foul.

Brines with economically appreciable lithium content have been discovered in produced oil field waters from evaporite carbonate reservoirs, suggesting the potential for significant lithium reserves to be accessible from geological formations which have already been mapped, drilled and produced. Water treatment operations are ubiquitous to upstream facilities for the treatment of produced waters before reinjection or disposal and as a consequence over a hundred years of technical experience has accrued in this industry regarding the treatment of natural produced waters from these types of geological reservoir. The intention of this patent is to adapt process wastewater treatment and electrochemical unit operations to extract and process lithium from produced brines in the field.

Several strategies for the electrochemical extraction of lithium from brines have developed over the last decade. Electrodialysis systems often rely on lithium selective membranes to allow lithium to cross from an anodic chamber into a cathodic chamber to produce a relatively concentrated lithium stream in the catholyte. The lithium selective membranes are often advanced materials such as ion-impregnated organic frameworks, metal-organic frameworks and similar as cheaper membranes used in lithium batteries do not possess sufficient lithium selectivity. These new membrane technologies can experience operational issues related to fouling and poor cycling performance, which has prompted some researchers to attempt electrodialysis systems which separate other ions from the lithium-containing brine to better facilitate downstream processing steps.

Recent research has moved towards electrochemical lithium extraction systems which more closely resemble lithium batteries during charging/discharging in order to take advantage of cheaper, more commercially abundant materials. These processes involve contacting traditional metal oxide electrodes with brine on the cathode side whereby lithium is intercalated into the metal oxide crystalline lattice. Once the cathodes are fully saturated with lithium, the anolyte and catholyte flow streams are swapped and the lithium-bearing electrodes are now turned to anodic operation such that they generate a lithium-enriched stream for further processing into a salt product such as lithium carbonate or lithium hydroxide.

Common lithium ion battery electrode materials include metal oxides such as LiCoO₂, LiMn₂O₄, LiFePO₄, nickel manganese oxides, nickel manganese cobalt oxides, sulfur or potentially pure lithium metal on a support for the cathode coupled with an anode comprised of graphite, nickel or other potential materials depending on the desired anodic reaction, cell operating voltage, etc. However only a subset of electrode materials are compatible with the lower operating voltages required for use in aqueous electrolytes. One example of such an electrode is LiFePO₄, which is able to intercalate and de-intercalate lithium ions in the range of 0.2-0.4V. Another example is λ˜MnO₂ which demonstrates excellent cycling performance with aqueous electrolytes. As lithium is the third smallest molecule it is able to preferentially intercalate into void spaces inside the lattice structures of certain metal oxides and other compounds, allowing the selective extraction of lithium ions from a brine containing high concentrations of molecules such as sodium, magnesium, calcium, potassium, etc.

Prior to the early 21^{st} century lithium carbonate was the primary industrial lithium salt product for glass production and other applications as it is easy to precipitate from concentrated lithium streams generated after the sequential precipitation of other salts such as NaCl, CaCl₂, etcetera as per typical practices described above. These processes often require many unit operations, consume a lot of energy per unit produced and considerable material inputs such as lime. In recent years lithium demand has shifted such that many industrial consumers such as battery manufacturers often seek suppliers of high purity lithium hydroxide, which often is created from a further processing of lithium carbonate or another lithium compound itself produced by the above methods described. Prior art exists to describe methods for the precipitation of lithium hydroxide from such prepared aqueous streams containing lithium compounds, constituting a solution containing an anion/cation pair with lithium being the cation (See CA 2,964,106 A1 or U.S. Pat. No. 9,034,295 B2) as opposed to a solution containing only lithium ions and water.

Despite the known prior art processes, there still exists a need for more efficient lithium extraction processes.

### SUMMARY OF THE PRESENT INVENTION

The present invention discloses a number of novel methods and embodiments which, when properly executed, enable scaled-up lithium extraction and salt production processes.

According to a first aspect of the present invention, there is provided a process which comprises a synergistic integration of multiple physical, chemical and electrochemical mechanisms into a single unit operation so as to reduce process footprint, material inputs and similar factors which dictate initial capital and operating expenses, while simultaneously minimizing the environmental impact of lithium extraction and processing. Specifically, this refers to the incorporation of electrolytic and potentially other electrodes discussed herein, into the same electrolyte-containing chambers as lithium-intercalating electrodes, which actually accomplish the selective lithium extraction from the brine, releasing it into a dilute or deionized solution, such that electrochemical extraction and recovery of lithium and at least the initial stages of salt precipitation are conducted in the same unit operation. Electrolytic and other electrochemical reactions can change the pH of the electrolyte they're in contact with and as such can potentially be used to encourage lithium intercalation in the presence of an appropriate active lithium-intercalating electrode material such as certain metal oxides or facilitate the precipitation of lithium salts following their de-intercalation from the same active material by increasing pH, as well as encourage lithium de-intercalation from appropriate lithium-intercalating absorbents by lowering pH which is a common means of lithium recovery from certain metal oxide sorbents, such as manganese oxides, nickel manganese oxides and similar. While conventional techniques would involve addition of material inputs to affect the electrolyte chemistry, this patent presents novel embodiments and methods for the incorporation of multiple electrodes and electrochemical reactions into the same unit operations so as to achieve superior performance in terms of lithium extraction, recovery and salt production from brines through process integration and automation.

According to a second aspect of the present invention, there is provided a process which incorporates a novel method for handling and operating the lithium-intercalating electrode materials used in the lithium extraction step which enable the process according to a preferred embodiment to operate efficiently at large scale. Prior art embodiments resemble conventional electrochemical cell stacks whereby electrodes are kept static in non-conductive spacers which simultaneously hold the electrode in place and act as the physical structure of the electrochemical cell stack system as a whole when joined with other spacers forming the electrolytic chambers and holding the membrane separator and counter electrode respectively. By contrast, the embodiments depicted herein either use electrode materials which are not kinematically fixed but instead move through the electrochemical system, or the spacers holding the electrodes are placed inside larger vessels which themselves are filled with brine or other electrolytes or the lithium-intercalating material exists as part of a packed bed wherein physicochemical and electrochemical driving forces work together to facilitate the efficacious extraction and recovery of lithium from brine. Each of these preferred embodiments have advantage which will be discussed in detail as follows.

According to another aspect of the present invention, there is provided a process which comprises the integration of an electrochemical control system into the process to facilitate the multiple electrochemical reactions taking place simultaneously in connection with the typical distributed control system found in process operations. This innovation enables embodiments comprising multiple electrodes incorporated into the same unit operation to combine electrolytic pH change with electrochemical lithium extraction and recovery, or conduct lithium extraction and recovery in the same vessel as salt precipitation, or to couple electrochemical lithium extraction and recovery to the electrochemical oxidation and/or reduction of other components in the brine to potentially generate side product streams, to cite some examples relevant to this patent. Such embodiments require input from an electrochemical control system to manage the timing of when current will be flowing through them, at what current density and/or voltage, etcetera which has to be synced up to such process control operations as the opening of valves, running of pumps, etcetera involved in filling the tanks with brine or other electrolytes and subsequently emptying them.

According to yet another aspect of the present invention, there is provided a method and a related set of preferred apparatus embodiments designed to combine the electrochemical extraction of lithium from brine and the precipitation of lithium hydroxide into a single integrated unit operation as well as a related process for implementing and operating the method such that challenges posed by the lithium-bearing resource and its management are addressed.

According to a preferred embodiment of the present invention, there is provided a process which can be used to produce lithium salt products from lithium-containing brines at scale by first pre-processing the brine to remove contaminants, then contacting the brine with a lithium-intercalating electrode to selectively capture and release lithium ions into a solution suitable for the precipitation of a lithium salt product. An advantage of a preferred embodiment according to the present invention is that the concentrated lithium solution produced by the electrode de-intercalation can then be induced to precipitate into lithium hydroxide directly without the creation or processing of intermediate lithium compounds. The precipitation and separation can occur in the same unit operation as its extraction or the precipitation can begin in the same unit operation to be completed in subsequent processing steps, such as separate crystallization vessels and spray drying tanks to result in a dry, saleable lithium salt powder.

An advantage of this preferred process is that it is relatively simple, with fewer unit operations necessary compared to most traditional lithium extraction and salt production processes, with the potential to require significantly fewer material and energy inputs as well.

Another advantage of this preferred process is that it has different operating constraints such that many compounds that would normally have to be removed to produce a lithium salt product are not issues in an electrochemical extraction system. Lithium-intercalating electrodes are generally selective even in high concentrations of sodium, magnesium and calcium which can present challenges to many separation processes.

Another advantage of a preferred embodiment of the present invention is that the process of electrochemical lithium extraction and recovery is integrated with electrolytic salt precipitation in the same unit operation, facilitated by the use of an electrochemical control system to manage the process and ensure each electrode is conducting current at the appropriate time and under the right conditions such that the intercalated lithium can be best recovered through the application of oxidative current and/or acidic pH, then precipitated from the same electrolyte chamber by an electrolytic electrode, such as a hydrogen generating electrode which can consume protons from the electrolyte raising the pH for crystallization of lithium hydroxide. The unit operation can then be modified to incorporate aspects which support the management of crystallized solids in fluid suspension such as augers, slanted walls, cyclones, fluidized beds and other methods relating to the conveyance, processing and manipulation of slurries and granular solids.

Another advantage of a preferred embodiment of the present invention, is that the process, is amenable to modular operation contrarily to the prior art processes. While traditional chemical process operations, including conventional lithium extraction processes relying on membranes, adsorbents, etc. are almost universally built as large process sites with many unit operations in close proximity, the process integration inherent to the embodiments, methods and designs described herein simplifies the extraction, recovery and lithium salt production process such that it is almost entirely accomplished by a single unit operation, potentially operating with some upstream pre-processing and downstream post-processing steps. Therefore, some embodiments described herein are more amenable to modular operation where unit operations and their accompanying process equipment are installed in the field, potentially at each well pad or similar, such that a product more suitable for immediate sale on the market can be produced at the site of resource extraction as part of said extraction. Such an operating paradigm may have significant advantages with respect to cost and lifecycle environmental impact over conventional methods.

Another advantage of a preferred embodiment of the present invention is that the method pertains to a preferred embodiment which incorporates roll-to-roll techniques for the manipulation and operation of the lithium-intercalating electrode material used to facilitate the lithium extraction and recovery steps. Such embodiments have a considerable advantage over prior art using conventional electrochemical cell stacks as the total lithium-intercalating capacity of the unit operation is dictated by total amount of active intercalating material on the electrode sheet, proportional to the total electrode surface area by the active material loading density. In a conventional cell stack the electrode sheets are held kinematically fixed in the electrolyte chambers, once they have become entirely saturated with lithium from brine intercalation the brine has to be dumped from the chamber, then the chamber refilled with a dilute electrolyte to carry the de-intercalated lithium. Each cycle of filling and dumping involves a number of valve actions and pump operations which take time and consume energy. In comparison to the static conventional cell which is limited by the entire systems width, height and cell count, there is significantly more active material surface area on an electrode sheet roll, which coincidentally is the form it commonly takes leaving the factory from which it was fabricated. Therefore, the potential roll to roll embodiments depicted herein can involve loading these rolls into cartridges, spools or similar then feeding them into brine containing unit operations to become saturated with lithium, assuming they have already been de-lithiated by the same or similar process as those described herein but under anodic oxidizing conditions. Such an embodiment has a total lithium intercalation capacity limited only by the size and quantity of electrode rolls available, consequently lengthening the time between cycles or eliminating the need to cycle electrolytes entirely.

Another advantage of a preferred embodiment of the present invention, is that the process can potentially eliminate the need to drain and fill electrolyte chambers by moving the electrodes from one step to another instead. These embodiments have a significant advantage over prior art in that the brine may not need enter the same chamber as the dilute solution used to accept the recovered lithium ions during de-intercalation. Typical lithium-containing brines possess a number of constituent ions, all of which represent potential contaminants to the final lithium salt product and purity can best be maintained by eliminating potential sources of contact. The potential roll-to-roll embodiments are particularly amenable to electrode cleaning operations that could not be incorporated into the more conventional methods in the prior art. Electrode rolls can be passed through particular chambers built into unit operations or cleaned separately before being fed back into the lithium extraction and recovery processes depicted herein, potentially almost eliminating contamination between the brine and final lithium salt product.

Preferably, pre-processing of the brine will likely be necessary to minimize fouling of the electrochemical system and any potential contamination of the electrode product as lithium-containing brines from natural resources, recycled waste streams and similar practical sources are typically comprised of a heterogenous mixture of ions and compounds. One potential embodiment could consist of an initial de-gassing of the produced fluid near the formation temperature in a crystallizer or similar vessel to remove dissolved gases while precipitating saturated carbonates and removing any produced fines/sand. Any hydrocarbons or other organic brine contaminants would also have to be removed by methods such as settling tanks, froth flotation, filtration, etc. This solution can then move to a second crystallizer at reduced temperature which can drop out halite and other potential highly saturated salts or silica which don't possess retrograde solubilities. Finally, the brine could be slightly re-heated before entering the electrochemical system to improve kinetics, reduce saturation indices and possibly re-collect heat lost in the second, cooler crystallization step. The particular brine pre-processing embodiment can vary considerably depending on the brine composition and properties, the only criteria is that the brine must be made chemically suitable to avoid fouling or contamination of the electrochemical system.

Some contaminants present in natural, lithium-containing brines can present unique difficulties to the operation of electrochemical systems in particular and may therefore also have to be removed as part of the pre-processing steps. One example of such may include bromine which is reactive and has a propensity to oxidize on anodic electrodes during the electrolysis of saline natural brines. To exemplify some of the methods for removing a contaminant such as bromine, in particular it can be removed by ion exchange, membrane separation, adsorption, selective oxidation or ozonation. The contaminant separation process itself or further processing steps may be designed and implemented to convert some of the generated waste streams into saleable products.

Many embodiments of the electrochemical system exist but, it requires at the least, a chamber, vessel, pipe, cell stack or tank in which the cathodic lithium-intercalation reaction occurs in contact with the pre-processed brine. This cathodic container holds the lithium-intercalating material which has somehow been prepared for suitable incorporation into the electrochemical system. Depending on the specific embodiment, this could include manufacturing or procurement of the electrode sheet or roll which is then placed in trays or onto a spindle or into a cartridge. Alternatively, this could involve combining the lithium-intercalating compound with binders, conductive additives and other components to produce a granular material or to otherwise add the lithium-intercalating compound onto a porous conductive support in the form of a surface film, doping agent, nanostructured material or another microstructural embodiment.

The cathodic container including the appropriately prepared lithium-intercalating material is then filled with pre-processed brine and the intercalating material is subjected to a constant current or voltage through the conductive support for a given period of time such that the lithium selectively enters the intercalating material.

The lithium-intercalating material is then contacted with a suitable solution to de-intercalate the lithium ions into. How this occurs can have many potential embodiments, one of which being that the cathodic container is drained, potentially washed or otherwise conditioned to minimize contamination and re-filled with a dilute or deionized solution for lithium de-intercalation. In another embodiment whereby the intercalating material exists as an electrode film on a roll of conductive backing material, the roll can be intercalated in a cathodic chamber and subsequently passed over into an anodic de-intercalation system or the roll, cartridge, etcetera can be transferred to another part of the electrochemical extraction system such that it can be fed into the anodic de-intercalation system without the necessity for draining and re-filling vessels, cell stacks or other potential electrolytic containers, further minimizing the potential for contamination.

At this point in the process, the anodic de-intercalation container will be filled with a dilute, lithium-enriched aqueous solution. There are many potential embodiments to convert this lithium-enriched solution into a lithium hydroxide salt product compatible with the process described herein. Electrolytic electrodes can be incorporated into the anodic de-intercalation system itself such that the lithium-enriched solution is subjected to electrolytic alkalization in the same vessel, container, etcetera it was de-intercalated into, with the caveat that the anodic de-intercalation system is designed to handle the separation of crystallized solids, potentially in the form of settling cones, fluidized beds, screw conveyors, knife gates, cyclones and similar embodiments designed for the handling of granular slurries and fluidized solids. Lithium de-intercalation is kinetically favourable to intercalation and as such it may be possible to conduct the electrolytic alkalization of the lithium-enriched solution while the intercalating cycle is still completing, favouring the potential to construct a single unit operation to integrate brine extraction and lithium salt production. However, it is important to note that pH increases at the cathode during electrolysis and as such the electrolytic alkalization electrode cannot be coupled with the lithium intercalation electrode but must instead be connected to a suitable anodic oxidation reaction. In addition to this it may be necessary to include other processing steps to achieve complete conversion of lithium ions into salt given a particular residence time, produce a pure product economically at particular temperatures and compositions, spray dry the granulated slurry to produce a dry salt product for storage in hoppers, etcetera and as such this process likely incorporates many potential unit operations.

Lithium-depleted brine can then be disposed of directly, subjected to further processing to satisfy environmental requirements or potentially used as feedstock for other processes to extract further value from the resource.

According to an exemplary embodiment of the present invention, the method comprises the following steps:
a. the preparation and incorporation of the lithium-intercalating material onto a conductive support and into the electrochemical system.
b. the pre-processing of the lithium-containing brines, which often derive from natural or recycled sources, to remove contaminants which may affect the electrochemical extraction process or otherwise cause operational issues.
c. the pre-processed brine enters a cathodic container in which it contacts the lithium-intercalating material.
d. a constant current or voltage is applied to the lithium-intercalating material through the conductive support such that lithium is selectively intercalated into the intercalating material from the brine.
e. either the lithium-intercalated material is transferred into another vessel, chamber, cartridge or similar to de-intercalate the lithium into an appropriately dilute solution or the cathodic container used for the brine intercalation step is drained, potentially washed and refilled with aforementioned de-intercalation solution.
f. a constant current or voltage is applied to the lithium-intercalating material such that the lithium is released back into solution, this time with minimal contamination of other brine ions.
g. this dilute lithium-containing solution is then either precipitated inside the same container as the de-intercalation took place or is subjected to one or more subsequent processing steps in the same or sequential unit operations to produce a pure LiOH salt product.

In another embodiment of the method, a lithium hydroxide or similar lithium salt is electrochemically deposited onto a suitable electrode surface under the application of controlled current, potential or both, such that the lithium salt product can be removed along with the current-conducting electrode material. Such an embodiment can include many preferred embodiments for how the salt-depositing electrode is incorporated into the electrochemical system such that it can be easily removed, such as trays, cell stacks, panels, or potentially deposited onto a roll or similar such that it can be scraped off into a suitable container, etcetera.

According to another embodiment of the method, lithium-intercalating supercapacitors are either used as the primary lithium extraction and recovery step by electrochemical intercalation or they are incorporated into the process as an initial, potentially less selective lithium concentrating step before the more selective electrochemical extraction and recovery steps.

According to another embodiment of the method, pH is increased by an electrolytic water-splitting electrode such as a hydrogen generating electrode incorporated into the same unit operation as exists a lithium-intercalating material which absorbs lithium under alkaline conditions. Such an operation can be assisted through the application of cathodic current through said lithium-intercalating electrode material during or immediately after the electrolytic alkalinisation.

According to another embodiment of the method, pH is decreased by an electrolytic water-splitting electrode in the same unit operation as exists lithium-intercalating material which is contains intercalated lithium such that the lithium is de-intercalated entirely or in part by the acidic conditions. Such an operation can be assisted through the application of anodic current through said lithium-intercalating electrode material during or immediately after the electrolytic acidification and may require the addition of material inputs such as hydrogen to conduct said reaction.

According to another embodiment of the method, the electrochemical lithium intercalation and/or de-intercalation reaction is coupled to another electrochemical reaction which is oxidizing or reducing a component of the brine, potentially resulting in the generation of an additional side product stream which may necessitate other processing unit operations parallel to the lithium process described herein.

According to another embodiment of the method, electrolytic acidification is used to treat the lithium depleted brine after it leaves the electrochemical extraction system to make it more geochemically suitable for reinjection into the formation.

### BRIEF DESCRIPTION OF THE FIGURES

Features and advantages of embodiments of the present application will become apparent from the following detailed description and the appended drawing, in which:

FIG. 1 is a diagram exemplifying a preferred embodiment of the process flow diagram described herein for extracting and processing lithium from brine;

FIG. 2 is a diagram exemplifying another preferred embodiment of the process flow diagram detailed herein for extracting and processing lithium from brine;

FIG. 3 is a diagram exemplifying another a preferred embodiment of the process flow diagram detailed herein for extracting and processing lithium from brine;

FIGS. 4 A-B are diagrams showing an example of the lithium extraction and salt precipitation process described herein, as well as some preferred embodiments of how multiple electrodes are incorporated together into a potential electrochemical system embodiment;

FIG. 5 depicts a potential embodiment of the process described herein whereby lithium extraction and lithium salt product precipitation are integrated into the same unit operation;

FIG. 6 demonstrates one potential embodiment of the process described herein whereby lithium extraction and recovery are integrated into the same unit operation using the roll to roll method without the need to cycle between brine and dilute electrolytes;

FIG. 7 illustrates one potential embodiment of the process described herein whereby the roll to roll electrochemical extraction and recovery method described herein in scaled up;

FIG. 8 is a diagram displaying one potential embodiment of the lithium extraction and concentration process whereby intercalating material on a conductive film roll is operated such that it can move from one side of the unit operation to another with a cleaning step to mitigate contamination;

FIGS. 9 A-D are some potential embodiments of the roll to roll lithium extraction and recovery process described herein;

FIGS. 10 A-B illustrate some potential embodiments of how the extraction of lithium using rolls of intercalating material can be scaled up;

FIGS. 11 A-D illustrate some potential embodiments of process described herein whereby a granular or similar form of the lithium-intercalating material is contacted with a conductive support or similar electrical connection for the electrochemical extraction and recovery steps;

FIG. 12 depicts preferred embodiments of process described herein whereby a granular or similar form of the lithium-intercalating material used to pack a process vessel on conductive porous trays is integrated with an electrochemical pH manipulation system built into the vessel walls;

FIG. 13 is a preferred embodiment whereby electrochemical lithium extraction, recovery and product salt precipitation are integrated into the same unit operation;

FIG. 14 illustrates a preferred embodiment for the lithium salt production process whereby brine is processed on site with modular unit operations and lithium saturated electrode rolls are used to produce salts at a central processing facility; and

FIGS. 15 A-B show the cathodic brine intercalation and anodic lithium de-intercalation unit operations respectively of a potential process embodiment whereby the roll to roll method and electrochemically induced precipitation are incorporated into the same unit operation.

Exemplary embodiments of the present invention will now be described below.

### DETAILED DESCRIPTION

Throughout the following description, specific details are set forth in order to provide a more thorough understanding to persons skilled in the art. However, well known elements may not have been shown or described in detail to avoid unnecessarily obscuring the disclosure. The following description of examples of the invention is not intended to be exhaustive or to limit the invention of the precise forms of any exemplary embodiment. Accordingly, the description and drawings are to be regarded in an illustrative, rather than a restrictive, sense.

The present description relates to the extraction of lithium from brines to produce a lithium salt product.

FIG. 1 presents an exemplary process flow diagram illustrating a potential embodiment of the general flows of material and energy essential to the process proposed herein, where lithium-containing brines (10) are first pre-processed (12) to remove potential contaminants (13) of the electrochemical system including hydrocarbons, precipitating salts and reservoir gases amongst other possibilities, then subjected to an electrochemical extraction (14) process whereby lithium ions are selectively removed from the brine and released into a fresh, dilute solution. In the particular embodiment shown, formation of lithium hydroxide is achieved by an electrochemical alkalization (16) of the dilute solution by cathodic water electrolysis coupled with an appropriate anodic counter-reaction, which can be chosen and incorporated into the system by a number of potential embodiments and design parameters discussed in this document. Crystallization (18) can be conducted entirely or partially in the electrolytic alkalization chamber in embodiments which are designed to better handle solids, discussed herein, or can include subsequent processing operations to further condition or complete the precipitation of lithium hydroxide from the dilute solution produced by electronic de-intercalation in the electrochemical extraction step. Subsequent evaporation, spray drying, cyclone drying, and related unit operations will generally also be necessary to produce a high quality dry lithium salt product (19).

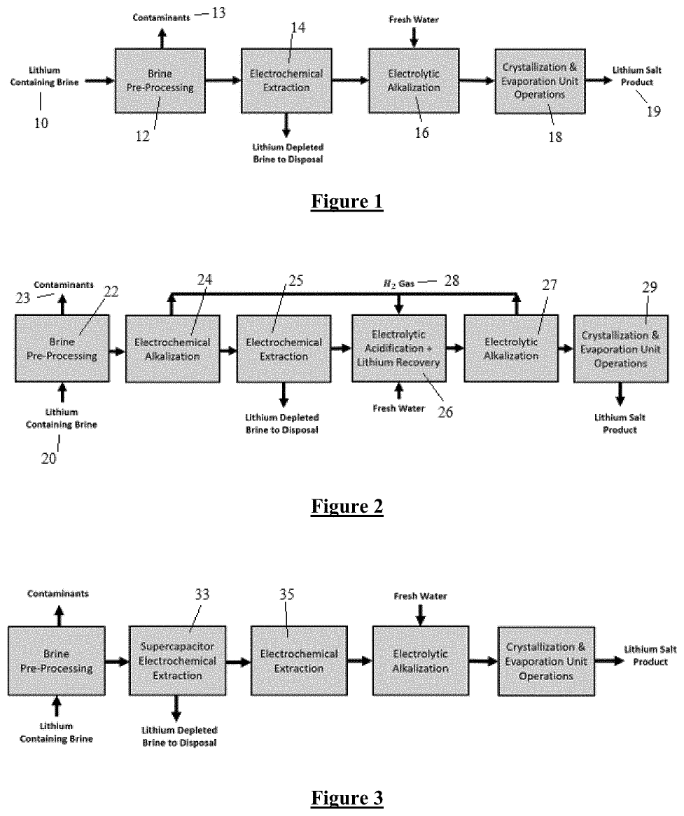

FIG. 2 depicts another exemplary process flow diagram whereby the ability to manipulate solution pH electrochemically is used to its full extent to enhance operational performance at each applicable step. After pre-processing (22) of the brine (20) to remove contaminants (23), potentially including hardness and other compounds which can precipitate at high pH, the brine can then undergo electrochemical alkalinisation (24). This can take many possible forms, but two potentialities of note include the use of a hydrogen generating, water splitting electrode operating at cathodic voltages to consume protons from the brine, or the use of alternative electrode materials such as graphite, nickel, and others to reduce and/or oxidize components in the brine depending on its composition such that the brine pH increases as the electrochemical reaction progresses. Such an increase in brine pH can facilitate the intercalation of lithium into particular electrode active materials such as manganese oxide, nickel manganese oxide and others. With multiple electrodes incorporated into the same unit operation and these electrodes operation managed by a central electrochemical control system, an additional electrode can be built into the same unit operation able to electrochemically lower the pH and de-intercalate the lithium from the active material, effectively recovering it to form a relatively pure aqueous lithium solution. Electrolytic hydrogen splitting (26) into protons is an electrochemical reaction able to lower the pH of an aqueous solution while not introducing any new ions into the system which would contaminate the purity of the final lithium salt product. In such an embodiment, due to the nature of the lithium-intercalating active material the final salt precipitation step by electrolytic alkalinisation (27) must be conducted in a separate unit operation from the electrochemical extraction (25) so as to avoid re-intercalation of the lithium into said active material. Again, water splitting is an electrochemical reaction able to modify aqueous pH without changing solution composition and consequently amenable to lithium salt precipitation with only energetic input and the potential of a hydrogen gas product which can be consumed in the electrochemical acidification step (26). Finally, a dry, saleable lithium product is produced by final crystallization, evaporation (29), spray drying and similar methods.

FIG. 3 shows a potential embodiment of the process described herein whereby a lithium-intercalating step utilizing a lithium-intercalating supercapacitor (33) material is used to provide an initial lithium concentration step before a subsequent lithium extraction (35) step accomplished by the electrochemical extraction techniques described herein. Supercapacitor materials include compounds such as graphite, molybdenum disulfide, silicon, and others as well as nanostructured derivatives of such materials and in general have faster lithium intercalation kinetics but potentially are less selective towards lithium versus other brine components often at hypersaline concentration. Therefore, it may be advantageous to combine an initial supercapacitor intercalation step which may be less selective but will result in a concentrated lithium concentration relative to the feed brine and may enhance overall throughput of the electrochemical extraction and recovery process which would then proceed as described herein.

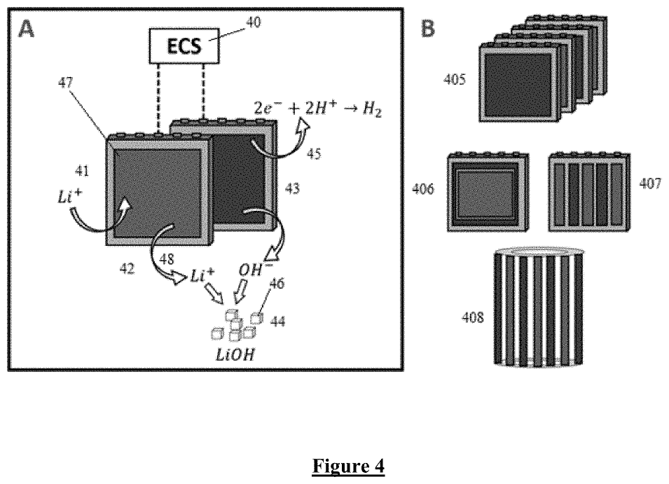

FIG. 4A illustrates the general principles behind the selective electrochemical extraction of lithium from brines combined with an electrolytic alkalization process to generate lithium hydroxide. In the first step (41), a cathodic voltage or current is applied to an appropriate lithium-intercalating electrode material (47) which selectively absorbs lithium from the lithium-containing brine. In the second step (42), lithium is released back (48) into a dilute solution through the application of an anodic voltage or current which causes the lithium to de-intercalate from the electrode material. In the third step (43), an appropriate electrolytic electrode then activates under an applied cathodic voltage or current which drives an electrolytic reaction (45), such as hydrogen evolution, which increases the pH of the dilute lithium-containing solution. The fourth step (44) results from the first three as the dilute lithium-containing solution can then be driven to precipitate lithium hydroxide (46) at a sufficiently high pH. It is preferable that this entire process must be managed by an Electrochemical Control System (ECS) (40) which acts as an interface between the Distributed Control System (DCS) for the whole process and the electrochemical system. In order to apply currents and/or voltages the ECS must incorporate some galvanostatic and/or potentiostatic circuitry and equipment respectively.

FIG. 4B demonstrates some potential embodiments for how the lithium-intercalating and electrolytic electrodes can be incorporated into the same unit operation to operate in sequential fashion. Arrangement 405 depicts the case in which lithium-intercalating and electrolytic electrodes exist in the same vessel, unit operation or electrolyte container on separate trays, plates or similar structural supports which incorporate a current collector and provide electrical connections to the ECS. Arrangement 406 and 407 depict the case where lithium-intercalating and electrolytic electrodes are incorporated onto the same structural support, both with their own unique current collectors and electrical connections to facilitate separate operation of each by the ECS. Arrangement 408 illustrates a potential embodiment whereby both electrodes are incorporated into a radial arrangement such they have separated electrical connections in a structural hoop or similar which allows integration with the ECS. Such an embodiment may be able to be stacked concentrically, potentially interspaced with appropriate anodic electrodes/anolyte chambers, to create a radial tower or similarly scaled up cylindrical embodiment for the electrochemical extraction unit operation.

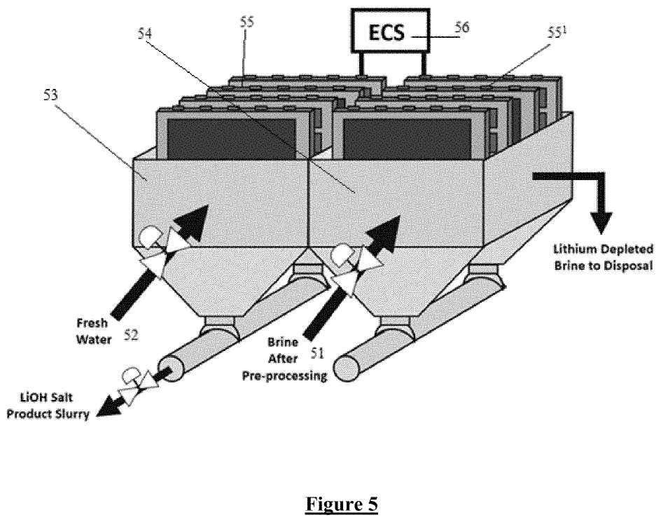

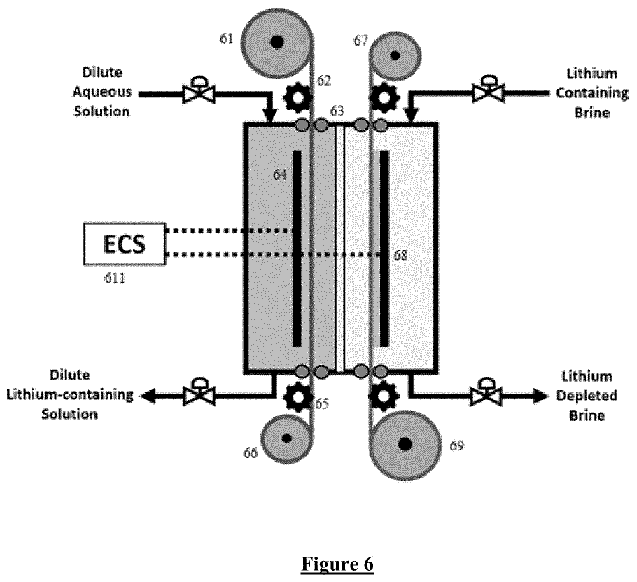

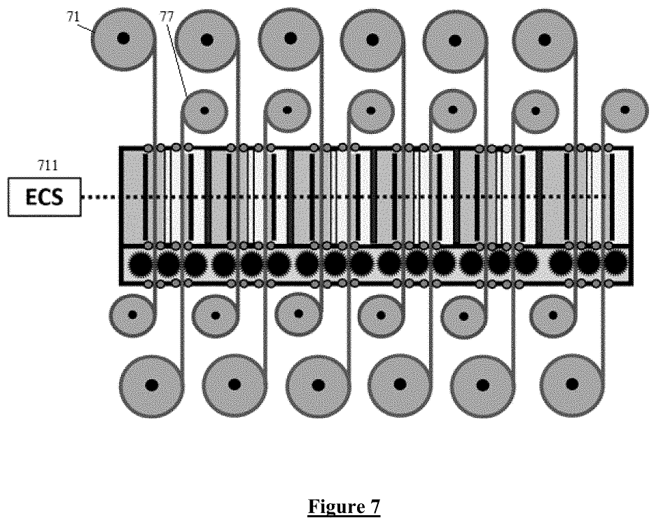

FIG. 5 depicts a preferred embodiment of the electrochemical lithium extraction and recovery process described herein integrated with electrolytic pH modifying electrodes in the same unit operation. In this particular embodiment, brine (51) and a dilute aqueous solution (52) are cycled between the two chambers (53 and 54) appropriately as otherwise described in this patent, while the multiple electrode system (55 and 55¹) exists as a stack of modular trays holding lithium-intercalating and hydrogen generating, water splitting electrodes respectively. Therefore in this embodiment, after the lithium depleted brine has been drained the electrochemical control system can receive a signal from the distributed control system to initiate the lithium recovery procedure by applying an oxidative current to the lithium-intercalating electrode coupled with a cathodic, proton consuming electrochemical reaction at the electrolytic electrode which is kept electrically separate from the lithium-intercalating electrode with no connection other than through the electrochemical control system (56). The embodiment depicted herein has been modified to better conduct the precipitation of the lithium salt product in said unit vessel by incorporation of sloped sides leading to an outlet at the vessel base. Such embodiments can include other modifications to further facilitate the effective conveyance of slurries and granular materials such as augers, gate valves and similar techniques in standard practice. Lithium intercalation from brine can occur simultaneously with lithium de-intercalation and precipitation in the same unit operation in this particular embodiment, with operating changing sides during each cycle.

FIG. 6 disclose a preferred embodiment for the electrochemical system (611) which will remove lithium from the produced brine by absorbing those ions into cathodic electrode material. In this embodiment, the lithium-intercalating material exists on a current collector backing which is in a roll on a spindle and/or incorporated into a suitable cartridge such as the anodic feed roll (61) which can be loaded into the unit operation and fed into the electrochemical system with assistance of a spool with a gear, such as the anodic feed spool (62), which can assist the electrode tape stay in alignment as it feeds with the gear teeth gripping perforations in the electrode tape edge, similar to photographic film. The electrode tape then feeds into the anolyte chamber through the anodic rollers (63) before contacting the anodic current collector (64) at which time the lithium is de-intercalated into the dilute aqueous solution, after which this electrode tape is then fed out of the anolyte chamber by the anodic output spool (65) onto the anodic output roll (66). A parallel operation is occurring on the side of the catholyte chamber, which in this case contains the lithium-containing brine, whereby the cathodic feed roll (67) is fed into the brine tank and passes over a cathodic current collector (68), during which time it undergoes an applied cathodic current or voltage such that it is able to electrochemically intercalate lithium from the brine before being fed onto the cathodic output roll (69). In this embodiment, separating the anodic and cathodic containers is a membrane such as an anion exchange membrane which can help maintain relatively constant pH during the electrochemical process to preserve electrode stability. The application of current and/or voltage to the anodic and cathodic current collectors is conducted by the electrochemical control system, which incorporates potentiostatic and/or galvanostatic elements while also integrating with the overall distributed process control system.

FIG. 7 illustrates a preferred embodiment whereby the cathodic intercalation and anodic de-intercalation chambers are assembled in such a way as to resemble a convention cell stack. Contrary to conventional electrochemical cell designs however, in this embodiment the electrode material has been attached to a current collector sheet able to exist as a roll and the electrode roll (71 and 77) is fed into the cathodic intercalation or anodic de-intercalation chamber respectively depending on whether lithium is being selectively extracted from the brine (blue electrode rolls undergoing reduction) or is being stripped from the electrode into a dilute or deionized solution (red electrode rolls undergoing oxidation). Current is being supplied to the electrode tape as it passes through the system by contact with a current collector plate, connected to the electrochemical control system (ECS) (711), which specifies the applied voltage, current, or any combination of electrochemical parameters the system can potentially measure and respond towards to optimize operation. In this preferred embodiment, an additional chamber has been included as a means to post-process the electrode tape as it leaves the respective electrolytic chambers, particularly the brine containing intercalation chamber as contaminants may exist as a film on the surface of the cathodic electrode tape or sheet such as sodium or bromine which are undesirable. However, it may also be beneficial for quality control to also clean the anodic electrode tape before it enters the de-intercalation chamber to minimize introduction of dust or other contaminants which the electrode roll may come in contact with outside of the electrochemical system and may be unwanted in the de-intercalation solution which should be nearly pure lithium ions and water. Therefore, a processing chamber can potentially be introduced which cleans the electrode tapes, possibly using many mechanisms of cleaning action such as electrostatic force, chemical treatment, mechanical agitation or brushing, contact with nanostructured surfaces or materials, and many others which achieve the desired outcome of removing contaminants from the electrode as it enters or exits one or both of the intercalation and de-intercalation chambers. One advantage of this system is that the total lithium intercalation capacity of the process is dictated by the size and loading of the electrode sheet rolls rather than the total quantity of absorbent that can be packed into a tower or vessel, which is the conventional process of selective lithium extraction by a lithium-intercalating sorbent. Once either fully saturated with or depleted of lithium the rolls can then be interchanged from the anodic de-intercalation spindle to the cathodic intercalation spindle or vice versa with human, mechanical or robotic assistance depending on the spindle system design. Not shown in this potential embodiment is the piping and surrounding system designed to manage the influx and draining of brine and dilute or deionized solution into and out of the cathodic intercalation and anodic de-intercalation chambers respectively.

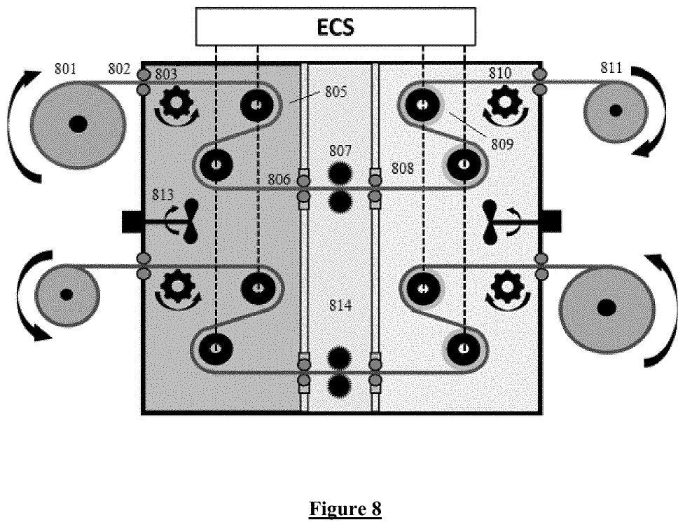

FIG. 8 discloses a potential embodiment of an electrochemical system designed to selectively extract lithium from brine, whereby the lithium-intercalating electrode exists on a tape or roll (801) on a spool or spindle. This electrode tape (801) is fed into the electrochemical system through rollers (802) with the assistance of a feed gear (803), which helps to maintain the electrode tapes alignment in the electrochemical system as the transit of the electrode tape is primarily driven by a motor powering revolution of the electrode product roll spindle (811). In this exemplary embodiment, the electrode tape passes over rollers with a current collector covering (804) over some or all of the spool surface. This current collector surface (404) is connected to the electrochemical control system (ECS) (812) which determines the current, voltage and/or potentially other electrochemical parameters of the connected current collectors. The electrode tape then passes through a membrane or physical barrier (805) using rollers (806) built into the electrochemical system structure to facilitate the electrode tapes transit without pulling on or otherwise interfering with the membrane or physical barrier. Use of a membrane allows transportation of cations or anions across the barrier during electrochemical operation which helps to minimize changes to anolyte/catholyte pH as the charge balances of the two chambers can be better equilibrated. However, in this potential embodiment a cleaning chamber has been incorporated between the two chambers to minimize contamination of brine into the dilute or deionized de-intercalation solution with the assistance of a mechanical brush (807) and potentially other cleaning mechanisms described herein, in which situation an impermeable physical barrier may be more appropriate, and pH will have to be managed with other chemical, electrochemical or other methods. The electrode tape then passes through another set of rollers (808) into the brine intercalation chamber to pass over another set of current collector rods (809), to be fed by the product roll gear (810) onto the electrode product roll spindle (811). Using the convention of FIG. 4 whereby blue electrode tapes are undergoing reduction and red electrode tapes oxidation, in this exemplary diagram the current collectors on the left hand, de-intercalation side (804) are turned off by the ECS while the right-hand side current collectors (809) in the brine intercalation will be turned on for the specific roll. The opposite case is then to be expected from the complementary system (814). Mixing of the catholyte and anolyte solutions by an agitator (813) or using a similar method improves the electrochemical kinetics happening at the electrode surfaces by reducing boundary layer effects. The advantage of the system illustrated is that once the electrode tapes have been fully fed through the system, they are immediately in a position to be fed back through the system the way they came, but the ECS will have reversed the current or voltage from performing a reductive intercalation to oxidative de-intercalation or vice versa, pulling lithium from the brine or stripping it back out of the electrode again cyclically. Not shown in this potential embodiment is the piping and surrounding system designed to manage the influx and draining of brine and dilute or deionized solution into and out of the cathodic intercalation and anodic de-intercalation chambers respectively.

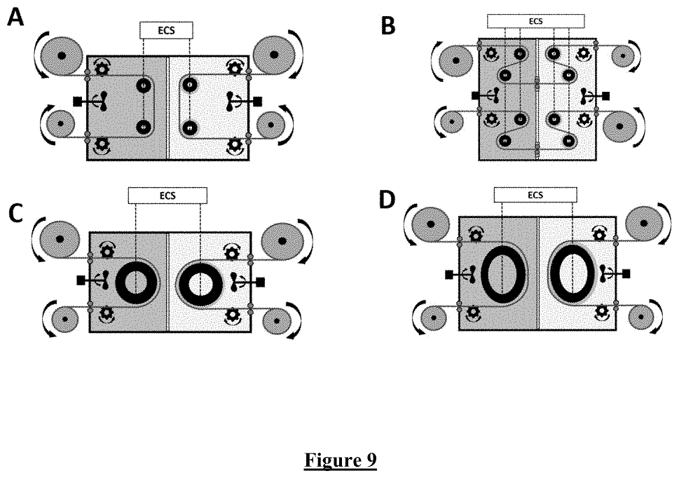

FIG. 9A depicts a preferred embodiment of an electrochemical lithium extracting system using the methods described herein whereby the cathodic and anodic rolls are kept separate to the cathodic and anodic chambers respectively. In such an embodiment, the rolls can be physically moved from one side to another after they're totally filled/stripped, or the brine chamber can be refilled with dilute solution and vice versa between cycles.

FIG. 9B shows a preferred embodiment of the methods described herein whereby the anodic and cathodic electrode tapes are fed through to their respective sides during operation, such that they can be fed back through the opposite direction under the alternate applied voltage and/or current to intercalate or de-intercalate lithium from the electrodes during each cycle.

FIG. 9C illustrates a preferred embodiment of an electrochemical lithium extracting system using the methods described herein whereby the cathodic and anodic rolls are kept separate to the cathodic and anodic chambers respectively. In this embodiment, the smaller current collector spindles have been replaced by a single, large cylindrical current collector spindle over which the electrode tapes pass. Such a design might increase the amount of surface area actively conducting electrons and consequently facilitating the electrode reaction, thereby increasing the rate at which an electrode roll can be filled or depleted of lithium.

FIG. 9D demonstrates a preferred embodiment of an electrochemical lithium extracting system using the methods described herein whereby the cathodic and anodic rolls are kept separate to the cathodic and anodic chambers respectively and the current collector spindles have been replaced by a single, large elliptical current collector spindle over which the electrode tapes pass. Such a design might even further increase the electrode surface area participating in the electrode reaction at a given moment. In such a system, the tensile force on the electrode tape will have to be considered along with its bending stress as it passes over the sharper elliptical corners in order to minimize mechanical breakage of the electrode tape, particularly after many multiple cycles.

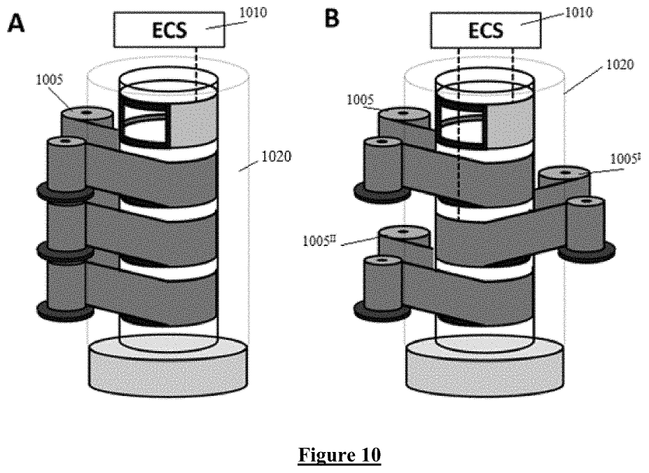

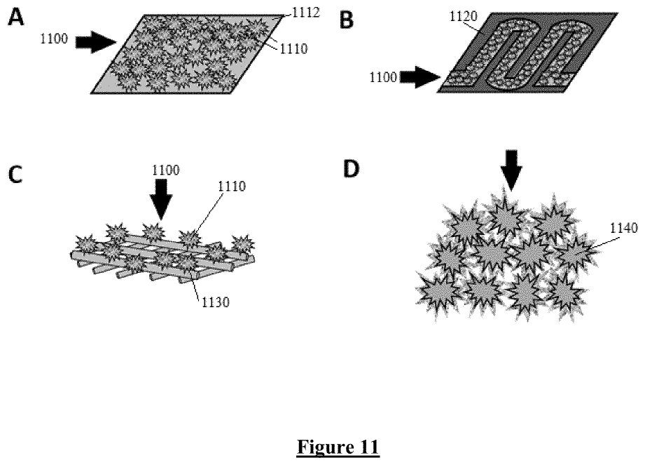

FIG. 10A disclosed herein is a preferred embodiment whereby the electrochemical intercalation and/or de-intercalation of lithium into electrode tapes from brine or into a dilute or deionized de-intercalation solution can be scaled up vertically in a tower design (1020). Electrode rolls (1005 can be stacked on one another in the form of cartridges, spools or spindles and fed into a large anolyte/catholyte tower depicted as the dotted cylindrical line. This tower can include a central current collector structure which the electrode tapes contact as they pass through the system. The current and/or voltage on these current collectors will be dictated by the electrochemical control system (ECS) (1010). Such a design may allow larger volumes of brine to be processed at once with a high surface area of electrode in contact with solution at any given time. In such a design, it may also be possible to collect the filled or depleted electrode rolls at the bottom once complete with fresh rolls fed into the top.

FIG. 10B demonstrates a preferred embodiment of the methods described in FIG. 10A but where cathodic intercalating rolls and anodic de-intercalating rolls (1005, 1005′, 1005″) can be incorporated into the same system to pass lithium from one another, likely with the conveyance of a dilute or largely deionized electrolyte solution filling the tower (1020). Such a system may be advantageous for subsequent polishing steps depending on the extent to which sodium or other contaminants may be picked up by the electrode surfaces or incorporate into the electrodes via competitive intercalation.

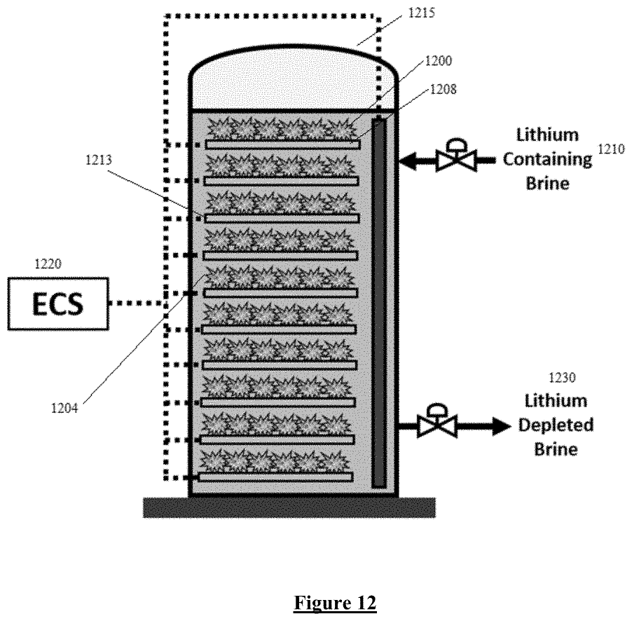

FIG. 11A presents a preferred embodiment of the methods described herein whereby the electrode material exists as a granular solid (1110) resting on a current collector (1112), over and/or through which the brine and de-intercalation solution (1100) pass alternately. Such an embodiment could exist as trays in a vessel through which fluid flows and lithium is extracted or released depending on the current and/or voltage applied to the current collector plate. Such an embodiment is an electrochemical extrapolation of conventional sorbent unit operations and methods. The vessel would likely require a layer of insulation between the packing and the metallic structure to prevent electrical shorts, losses or other safety and operational issues.

FIG. 11B illustrates a preferred embodiment of the methods described herein whereby the embodiment of FIG. 11A is modified to restrict the granular electrode sorbent and fluid flow (1100) to tortuous channels (1120) designed to increase the fluid's residence time in contact with the electrode material to further improve the processes efficacy. As with FIG. 11A, the current collector at the bottom of the channels will have an applied current and/or voltage in connection with an electrochemical control system as described above.

FIG. 11C shows a preferred embodiment of the methods described herein whereby the electrode material exists as a granular solid (1110) in contact with a mesh-like current collector (1130) to facilitate fluid flow (1100) through a vessel packed bed. In this and other potential embodiments it may be necessary to use an electrode material which has a higher fraction of conductive additives to address the additional current and mass transfer resistances present in the granular case in comparison to when the electrode material is calendared onto a current collecting sheet, tape or similar.

FIG. 11D depicts a preferred embodiment of the methods described herein whereby the electrode material is added as a surface coating onto a granular current collecting substrate for incorporation into a packed bed (1140) or similar vessel. Such a system would also require electrical connection to an electrochemical control system and electrical conduction through the packed bed would depend on the packing structure of the granular electrode-covered particles and how well they're connected in terms of contacting surface area. Such a design is advantageous in its simplicity as it is the electrochemical extension of the convention sorbent process but the electrical transport resistance in the packed bed may discourage such an operating paradigm.

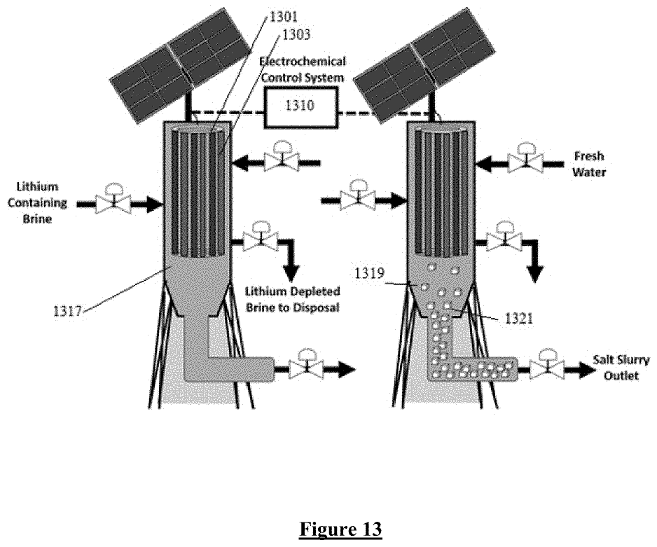

FIG. 12 illustrates a preferred embodiment for the methods described herein whereby a packed bed or similar vessel (1204) is filled with a granular material (1206) incorporating lithium-intercalating electrode material on conductive porous trays (1208) incorporates electrochemical pH manipulation for enhanced operational performance. In such an embodiment, lithium-containing brine (1210) can be pumped into a process tower (1215), vessel or similar filled with a granular material (1206) somehow incorporating a lithium-intercalating active material, be it as part of a simple mixture with conductive material, as a surface coating on a conductive substrate, as part of a nanostructured material or other, sitting on or incorporated into a porous, conductive packing structure such as mesh trays or similar. This conductive bed (1213) must be connected to the electrochemical control system (1220) which manages the timing, voltage, current and other aspects of the electrode's electrical behaviour such that it can conduct reductive currents while in contact with brine to achieve effective intercalation and conduct oxidative currents to de-intercalate the lithium from the electrode into dilute aqueous solution. Incorporation of an additional electrode built into the unit operation structure, in this example the vessel wall, necessarily placed in a non-conductive fitting able to prevent short circuits or electrical connection to the packed bed, which is able to increase the brine pH, potentially by splitting water to convert protons into hydrogen, thereby facilitating enhanced lithium intercalation into particular active electrode materials. Not shown is the subsequent step, coordinated by the process control system, which involves completing drainage of lithium depleted brine (1230) followed by re-filling of the unit operation with dilute solution and lithium recovery by de-intercalation, which can also potentially be enhanced by electrolytic acidification using additional electrodes also incorporated into the unit operation.

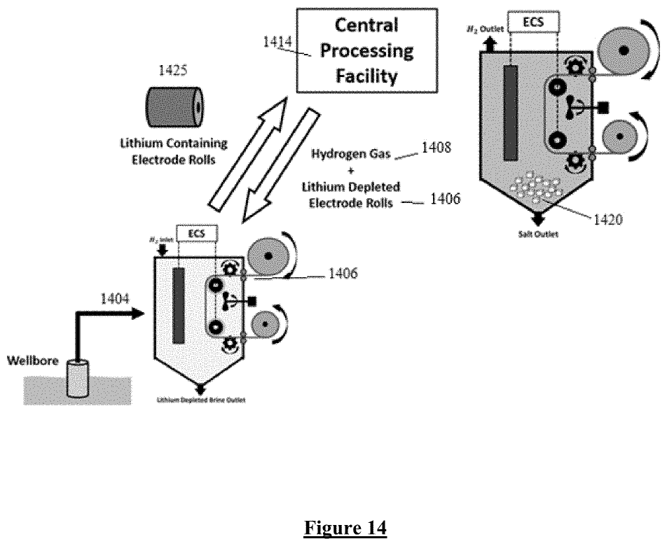

FIG. 13 is an example of a preferred embodiment whereby the electrochemical lithium extraction, recovery and salt precipitation methods described herein are integrated together into modular unit operations able to generate a near saleable lithium salt product with only lithium-containing brine and electricity as inputs. In this embodiment, multiple electrodes (1301, 1303) are incorporated into a non-conductive radial structure (1317), within which conductive wires run to connect the two types of electrodes separately to the electrochemical control system (1310). Multiple such electrode wheels can be nested within each other's luminal space to fill the whole cylindrical volume and maximize active material surface area in contact with solution while the cylindrical tower design with conical bottom outlet (1319) can be particularly conducive to the conveyance of precipitated solids (1321), especially if additional modifications are included such as gate valves to manage the salt outlet stream. As with other embodiments in this patent, these unit operations would cycle between filling with lithium-containing brine and cathodic lithium intercalation activated by the electrochemical control system followed by draining of the lithium depleted brine, refilling of the vessel with a dilute aqueous solution followed by anodic de-intercalation of the lithium coupled with electrolytic alkalinisation to precipitate a lithium salt product. Both unit operations are depicted together to show how operation can be cycled between them.

FIG. 14 illustrates a preferred embodiment for the lithium production process described herein whereby lithium extraction from the brine (1404) is achieved by intercalation into electrode rolls (1406) in modular unit operations at the resource site, facilitated by the consumption of hydrogen gas (1408) which provides the anodic counter reaction to the cathodic lithium intercalation reaction. In this embodiment, once electrode rolls have become fully saturated with lithium they are transported to a central processing facility (1414) to undergo the reverse operation and yield a lithium salt product (1420), simultaneously producing hydrogen via electrolytic alkalinisation through water splitting which can then be transported back to the well sites with a small pipeline, by canisters or other vessels, or through other methods of gas transport to effectively provide an energetic input for the intercalation reaction. Pumping liquids is one of the main expenses of any lithium extraction operation and the modular design depicted in this embodiment may be able to reduce pumping costs by transporting electrode rolls (1425) instead, which can potentially replace hundreds of cubic metres of brine equivalent. Such an embodiment necessitates that hydrogen gas and lithium depleted electrode rolls are then sent back to field sites to continue the production cycle.

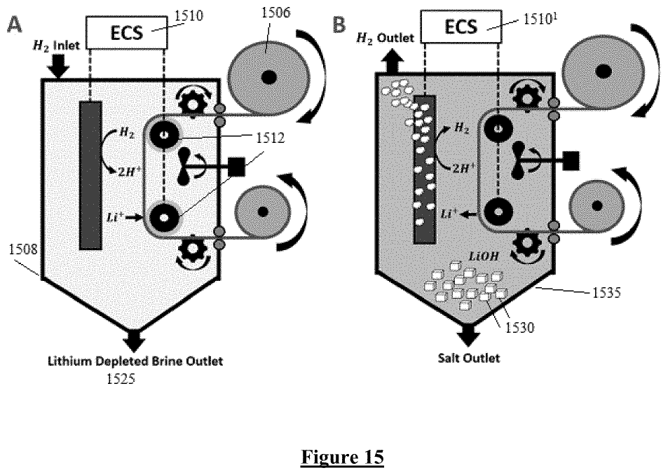

FIGS. 15A and 15B show two potential embodiments for the methods described herein whereby multiple electrode systems and the roll to roll method are incorporated into the same unit operation, with their function coordinated by the electrochemical and process control systems in concert. FIG. 15A depicts an embodiment where an electrode roll (1506) that does not contain lithium is fed into a brine containing chamber (1508) and subjected to a cathodic current by the electrochemical control system (1510) to achieve the selective interpolation of lithium into the electrode roll as it passes over the conducting rollers (1512), potentially made from a conductive material relatively suitable for electrochemical operation in saline fluids such as copper. In this embodiment, the cathodic intercalation reaction is coupled with an anodic hydrogen consuming reaction using an appropriate electrode material such as carbon, nickel, platinum, nanostructure materials or any one of many potential options, with hydrogen gas for the reaction supplied through an inlet incorporated into the unit operation. It is worthy of note that the active electrode material on the roll in this embodiment should not be the same active material used in embodiments depicted herein that use changes in pH to achieve intercalation/de-intercalation as the hydrogen consuming reaction will decrease the brine pH and consequently would shift the thermodynamic equilibrium of some active materials towards de-intercalation, inhibiting effective operation. Following depletion of lithium from the brine it can be drained (1525) from the vessel and potentially reinjected back into the formation or further processed to meet legal standards for disposal water compositions.

FIG. 15B illustrates a potential embodiment whereby the roll to roll method is coupled with an electrolytic hydrogen generating reaction to precipitate a lithium salt product (1530) while simultaneously recovering it from the electrode material absorbent used to extract it from the brine. This can be achieved by combining the anodic lithium de-intercalation reaction from an electrode roll while generating hydrogen using a cathodic reaction at a suitable counter electrode to increase the pH of the aqueous electrolyte. Such a system may require the addition of input energy from the electrochemical control system (1510¹) but has the advantage of retaining product purity and resulting in the production of a potentially useful hydrogen gas product. The resulting lithium salt (1530) can then be conveyed out of an appropriately designed bottom outlet (1535) before further processing to result in a dry, saleable salt product.

While the foregoing invention has been described in some detail for purposes of clarity and understanding, it will be appreciated by those skilled in the relevant arts, once they have been made familiar with this disclosure that various changes in form and detail can be made without departing from the true scope of tie invention in the appended claims.

What is claimed is:

1. A method for extracting lithium from brine, said method comprising the steps of:
providing a brine containing lithium;
processing the brine to remove contaminants;
submitting the brine to an electrochemical extraction of lithium;
disposing of the lithium-depleted brine;
recovery of the extracted lithium to produce a lithium solution;
performing an electrolytic alkalization on the lithium solution;
exposing the lithium solution to crystallization and evaporation; and
recovering the lithium salt resulting therefrom.

2. The method of claim 1, wherein the electrochemical extraction of lithium is performed by exposing said brine to an appropriate lithium-intercalating electrode material under appropriate conditions for a period of time sufficient to selectively capture lithium ions present in the brine.

3. The method of claim 2, where the lithium ions extracted from the brine are released into a solution suitable for precipitation of a lithium salt product.

4. The method according to claim 2, where the lithium-intercalating electrode material is selected from the group consisting of: iron phosphate; manganese oxide; cobalt oxide; nickel manganese oxide; nickel manganese cobalt oxide; molybdenum disulfide; silicon; graphitic carbon, a suitable compound nanostructured or other lithium intercalating materials.

5. The method according to claim 2, where said precipitation can be induced and optimized through physical, chemical and/or electrochemical mechanisms in either the same unit operation or in a subsequent unit operation.

6. The method according to claim 2, where the concentrated lithium solution produced by electrode de-intercalation is subjected to one or more polishing steps to further condition the solution chemistry.

7. The method according to claim 2, where the electrochemical lithium intercalation and/or de-intercalation reaction is coupled to another electrochemical reaction which is oxidizing or reducing a component of the brine, resulting in an additional side product stream.

8. The method according to claim 2, where the electrochemical lithium intercalation and/or de-intercalation reaction is conducted using a roll to roll technique for manipulating electrode rolls.

9. The method according to claim 2, where the electrochemical lithium intercalation and/or de-intercalation reaction using suitable electrode active materials is facilitated by electrochemical pH alteration using alternate electrodes incorporated into the same process.

10. A process for managing a lithium-containing brine resource, wherein said process comprises a step of:
pre-processing inlet fluids to remove contaminants;
removing of lithium from said inlet fluid; and
pumping said lithium-depleted brine into an appropriate formation for disposal.

11. The process for managing a lithium-containing brine resource according to claim 10, wherein said lithium-depleted brine is re-injected back into the resource for pressure support.

12. The process for managing a lithium-containing brine resource according to claim 10, further comprising a processing step to produce other elements from the lithium-depleted brine.
